(19) United States
(12) Patent Application Publication
(10) Pub. No.: US 2013/0129947 A1
(43) Pub. Date: May 23, 2013

(54) GLASS ARTICLE HAVING HIGH DAMAGE RESISTANCE

(71) Applicants: Daniel Ralph Harvey, Beaver Dams, NY (US); Alexander Mikhailovich Streltsov, Corning, NY (US)

(72) Inventors: Daniel Ralph Harvey, Beaver Dams, NY (US); Alexander Mikhailovich Streltsov, Corning, NY (US)

(21) Appl. No.: 13/299,901

(22) Filed: Nov. 18, 2011

(51) Int. Cl. B32B 1/02; B26F 3/00; B32B 7/02; B32B 17/00; B32B 3/02

(52) U.S. Cl. 428/34.4; 428/192; 428/141; 428/216; 225/1

(57) ABSTRACT

A glass article having strengthened surfaces joined by at least one edge. The strengthened surfaces are under compressive stress. The glass article also has an inner region that is under a tensile stress of greater than about 40 MPa. The edge includes at least one fracture line that is parallel to the surfaces. A first portion of the edge is under compression and a second portion is under tension. The edge is formed by irradiating a glass mother sheet with a laser to form a damage line within the central region laser and separating the glass article from the mother sheet.

### BACKGROUND

The disclosure relates to a glass article having a strengthened surface layers joined by at least one edge.

Glass parts for applications such as, for example, electronic communication, entertainment, and information terminal devices, are currently manufactured from ion exchanged or tempered “mother” glass sheets. For applications such as touch screens, thin film patterns of conductive materials such as indium tin oxide or the like are sometimes deposited onto a strengthened glass mother sheet before it is cut or separated into parts for final use. Due to manufacturability and cost considerations, the glass mother sheet is often cut into parts after deposition of such thin films.

One advantage of the ion exchanged glass is its high damage resistance compared to, for example, tempered soda lime glass. Damage resistance increases as the compressive stress (CS) and depth of the ion exchange layer (DOL) increases. However, due to the inability of commonly used laser and mechanical cutting techniques to reliably separate strengthened glass having a central tension (CT) that exceeds 20-30 MPa, the use of such high damage resistant glass in touch screens and other applications is limited to those glasses in which the central tension does not exceed this limit.

### SUMMARY

A glass article having strengthened surfaces joined by at least one edge is provided. The strengthened surfaces are under compressive stress. The glass article also has an inner region that is under a tensile stress of greater than about 40 MPa. The edge includes a first portion that is under compression and at least one fracture line that is essentially parallel to the surfaces and outside the first portion. The edge is formed by irradiating a glass mother sheet with a laser to form a damage line within the central region laser and separating the glass article from the mother sheet.

Accordingly, one aspect of the disclosure is to provide a glass article. The glass article has a thickness t, a length w, and a length l, and comprises a first surface and a second surface parallel to the first surface, wherein each of the first surface and the second surface comprise a layer under a compressive stress; a central region between the first surface and the second surface, wherein the central region is under a tensile stress; an edge joining the first surface and the second surface, wherein a first portion of the edge is under compressive stress; and a fracture line on a portion of the edge that is outside the first portion, wherein the fracture line is essentially parallel to the first surface and the second surface, and wherein the glass article is under zero thermal stress.

A second aspect of the disclosure is to provide a glass article. The glass article comprises: a first surface and a second surface parallel to the first surface, wherein each of the first surface and the second surface comprise a layer under a compressive stress CS, the layer extending to a depth of layer of at least about 40 μm from each of the first surface and the second surface into the glass article; a central region between the first surface and the second surface, wherein the central region is under a tensile stress CT of greater than 40 MPa; and an edge joining the first surface and the second surface, wherein a first portion of the edge is under a compressive stress.

These and other aspects, advantages, and salient features will become apparent from the following detailed description, the accompanying drawings, and the appended claims.

### BRIEF DESCRIPTION OF THE DRAWINGS

FIG. 1a is a cross-sectional schematic view of a strengthened glass article;

FIG. 1b is a perspective schematic view of a strengthened glass article;

FIG. 2 is a probability plot of surface damage resistance, as determined from abraded ring-on-ring testing, for various glass samples;

FIG. 3 is a micrograph of a frontal view of an edge of a strengthened glass article having three fracture lines;

FIG. 4a is a schematic top view of a strengthened glass mother sheet from which a glass article is separated by laser separation;

FIG. 4b is a schematic cross-sectional view of the formation of damage lines in a strengthened glass mother glass sheet by laser irradiation;

FIG. 5 is a photograph showing a top view of strengthened glass articles having various shapes and aspect ratios that were produced by laser separation;

FIG. 6a is a histogram of width measurements for 10.4 mm×100 mm laser separated glass parts; and

FIG. 6b is a histogram of width measurements for 55.75 mm×100 mm laser separated glass parts.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified.

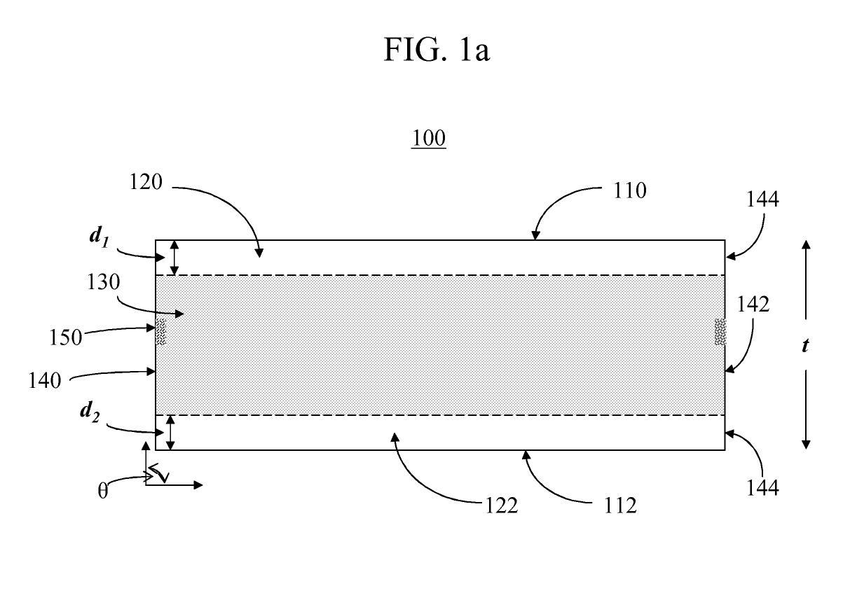

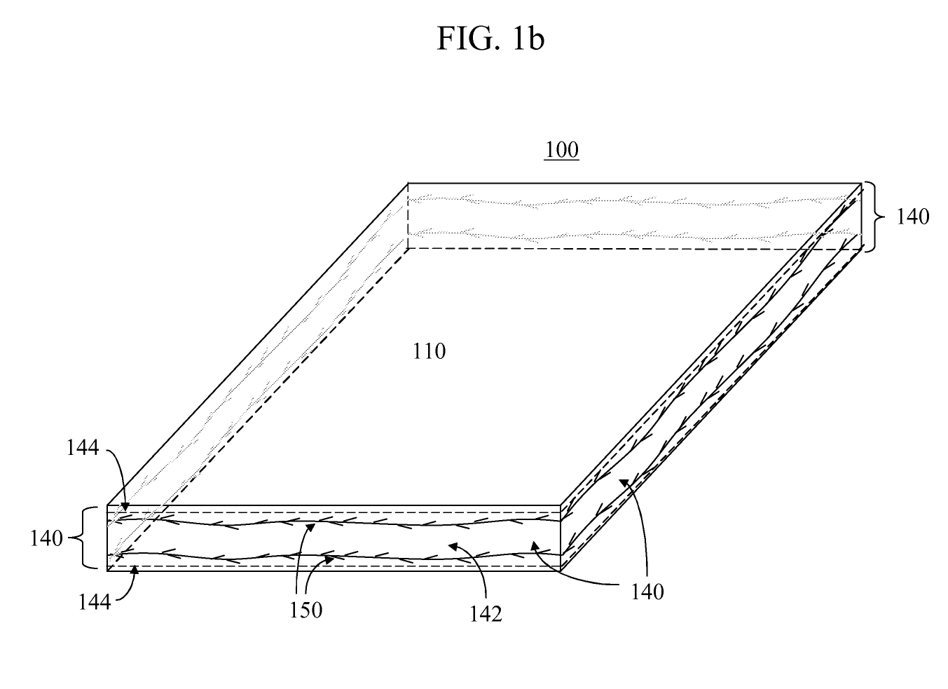

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

Glass parts for applications such as, for example, touch screens and panels, display panels and screens, windows, and the like, for use in electronic communication, entertainment, and information terminal devices, are currently manufactured from ion exchanged or tempered “mother” glass sheets. In the case of touch screens, for example, thin film patterns of conductive materials such as indium tin oxide or the like are deposited onto the strengthened glass mother sheet before it is cut (separated) into parts for final use. Due to manufacturability and cost considerations, the glass mother sheet is cut into parts after deposition of such thin films.

One advantage of the ion exchanged glass is its high damage resistance compared to, for example, tempered soda lime glass. Damage resistance increases as the compressive stress (CS) and depth of the ion exchange layer (DOL) increases. However, due to the inability of commonly used CO₂ laser and mechanical cutting techniques to reliably separate strengthened glass having a central tension (CT) that exceeds 20-30 MPa, the use of such high damage resistant glass in touch screen applications is limited to those glasses in which the central tension (CT) does not exceed 40 MPa.

Described herein is a glass article having high resistance to impact damage. The glass article is strengthened and has outer surfaces that are under compressive stress, a central region that is under a tension (central tension) of at least 40 MPa, and edges joining the outer surfaces. A portion of at least one of the edges is not under compression. In some embodiments, that portion may be under compression.

Cross-sectional and perspective schematic views of the strengthened glass article are shown in FIGS. 1a and 1b, respectively. Glass article 100 is chemically and/or thermally strengthened and has a thickness t, first surface 110, and second surface 112. Glass article, in some embodiments, has a thickness t of up to about 1 mm. In some embodiments, thickness t is in a range from about 0.3 mm up to about 2 mm and, in other embodiments, in a range from about 0.3 mm up to about 3 mm. While the embodiments shown in FIGS. 1a and 1b depict glass article 100 as a flat planar sheet or plate, glass article may have other configurations, such as three dimensional shapes or non-planar configurations. Glass article 100 has a first compressive layer 120 extending from first surface 110 to a depth of layer (DOL) d₁ into the bulk of the glass article 100. In the embodiment shown in FIG. 1a, glass article 100 also has a second compressive layer 122 extending from second surface 112 to a second depth of layer d₂. Depths d₁, d₂ of first and second compressive layers 120, 122 protect the glass article 100 from the propagation of flaws introduced by sharp impact to first and second surfaces 110, 112 of glass article 100, while the compressive stress in these layers minimizes the likelihood of a flaw penetrating through the depths d₁, d₂ of first and second compressive layers 120, 122. In some embodiments, first and second compressive layers 120, 122 each extend to a depth d₁, d₂, respectively, of at least 40 μm and, in particular embodiments, to a depth of at least about 50 μm. In some embodiments, depths d₁, d₂ of each of first and second compressive layers 120, 122 comprise at least 5% of the total thickness t of glass article 100 and, in some embodiments, at least 10% of the total thickness t. Compressive layers 120, 122 are each under a compressive stress of at least 400 MPa and, in some embodiments, at least 900 MPa.

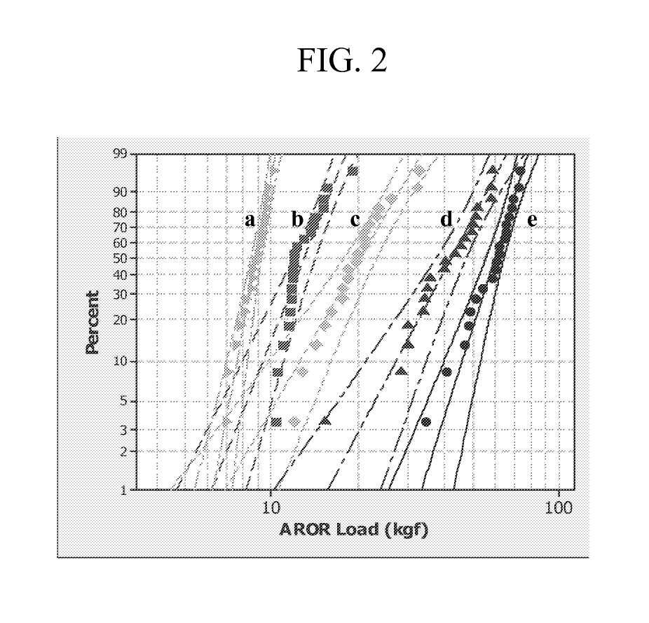

FIG. 2 is a probability plot of surface damage resistance, as determined from abraded ring-on-ring testing, for: a) a soda lime glass sample that is similar to those typically used in touch screen applications; b) an ion exchanged alkali aluminosilicate glass having a central tension (CT) of 24 MPa; c) an ion exchanged alkali aluminosilicate glass having a CT of 30 MPa; d) an ion exchanged alkali aluminosilicate glass having a CT of 40 MPa; and e) an ion exchanged alkali aluminosilicate glass having a CT in the range 42-44 MPa. Samples b-e have a nominal composition of 66 mol % SiO₂; 10 mol % Al₂O₃; 0.6 mol % B₂O₃; 14 mol % Na₂O; 2 mol % K₂O; 6 mol % MgO; 0.6 mol % CaO; 0.01 mol % ZrO; 0.2 mol % SnO₂; and 0.008 mol % Fe₂O₃. The data plotted in FIG. 2 show that those alkali aluminosilicate glasses having higher levels of ion exchange and higher CT values have higher damage resistance, and that higher stress levels in the glass (higher CT) result in higher surface damage resistance. Thus, strengthened glass articles having a central tension of greater than 40 MPa exhibit better damage resistance and are potentially more attractive for use as touch screen and for other applications.

Glass article 100 also has a central region 130 that extends from d₁ to d₂. Central region 130 is under a tensile stress or central tension (CT), which balances or counteracts the compressive stresses of layers 120 and 122. In some embodiments, the central region is under a tensile stress of greater than about 40 MPa. In some embodiments, the upper limit of central tension CT is given by the expression −38.7(MPa/mm)·ln(t(mm))+48.2(MPa), wherein CT is expressed in megaPascals (MPa) and t is expressed in millimeters (mm), and 40 MPa≦CT(MPa)≦−38.7(MPa/mm)·ln(t)(mm)+48.2(MPa). When the central tension exceeds this upper limit of central tension, the glass article is susceptible to frangible behavior; i.e., multiple crack branching with forceful energetic ejection of fragments upon sharp point impact resulting from excessive internal or central tension CT within the article. Frangible behavior is characterized by at least one of: breaking of the strengthened glass article (e.g., a plate or sheet) into multiple small pieces (e.g., ≦1 mm); the number of fragments formed per unit area of the glass article; multiple crack branching from an initial crack in the glass article; violent or forceful ejection of at least one fragment a specified distance (e.g., about 5 cm, or about 2 inches) from its original location; and combinations of any of the foregoing breaking (size and density), cracking, and ejecting behaviors. The upper limit of central tension and frangible behavior are described in U.S. patent application Ser. No. 12/537,393, filed on Aug. 7, 2009, by Kristen L. Barefoot et al. and entitled “Strengthened Glass Articles and Methods of Making,” the contents of which are incorporated herein by reference in their entirety.

Edges 140 connect first and second surfaces 110, 112 at angle θ (FIG. 1a). In some embodiments, angle θ is within 5% of a predetermined angle such as, for example, 90°. Edges 140 comprise portions 144 that are under compressive stress and a portion 142 that is outside portions 144 and not under compressive stress. Edge 140 is a cut surface formed by a cutting or separation process such as, for example, the laser separation process described herein below.

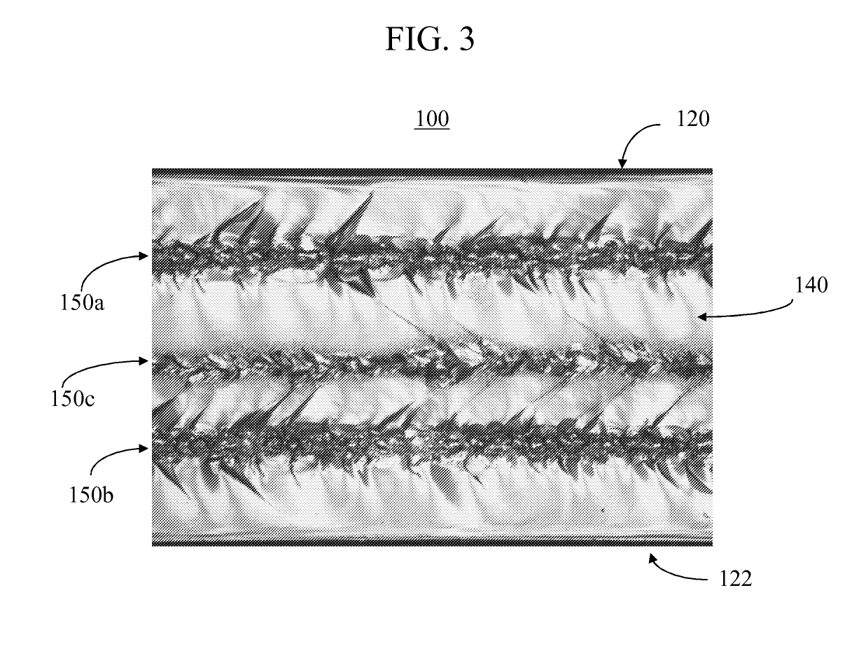

A representative fracture pattern, which is characterized by at least one fracture line 150 that is parallel to first surface 110 and second surface 112, is present in edge 140. The at least one fracture line 150 is present in that portion 142 of edge 140 that is outside portions 144 and not under compressive stress. As used herein, the terms “fracture line,” unless otherwise specified, refers to a continuous series of microfractures that form a line on edge 140. A micrograph of frontal view of an edge 140 having three fracture lines 150a, 150b, 150c is shown in FIG. 3. Fracture lines 150a, 150b, which are located closer to the first and second surfaces 110, 112, respectively, and outside portions under compressive stress 144 are formed by irradiating glass article 150 with an ultraviolet (UV) laser to form a damage line in a strengthened glass mother sheet or sample and then separating or splitting the glass article 100 from the mother sheet along the damage line. Fracture line 150c, which is located near the center of edge 140, is formed as a result of the collision of cracks propagating at an angle from fracture lines 150a and 150b. The fracture lines are essentially parallel to surfaces 110, 112 and compressive layers 120, 122. The term “essentially parallel to” means that each of the fracture lines may be parallel to or deviate slightly from parallel, and do not intersect either surfaces 110, 112 and compressive layers 120, 122.

Edge 140 has an overall or average RMS roughness of at least about 0.5 μm. The at least one fracture line 150 (e.g., 150a, 150b, 150c in FIG. 3) has an average roughness of about 3.2 μm, and the remainder of edge 140 (i.e., those portions of edge 140 that are outside of the at least one fracture line 150) has an average roughness of about 1.6 μm. Edge 140 and glass article 100 are also free of any thermal residual stress. The absence of such thermal stress in turn generates little or no stress induced birefringence in edge 140 and within glass article 100.

Glass article 100 may comprise or consist of any glass that is either thermally or chemically strengthened by those means known in the art. In one embodiment, the strengthened glass article 100 is, for example, a soda lime glass. In another embodiment, strengthened glass article 100 is an alkali aluminosilicate glass.

In one embodiment, the alkali aluminosilicate glass comprises: from about 64 mol % to about 68 mol % SiO₂; from about 12 mol % to about 16 mol % Na₂O; from about 8 mol % to about 12 mol % Al₂O₃; from 0 mol % to about 3 mol % B₂O₃; from about 2 mol % to about 5 mol % K₂O; from about 4 mol % to about 6 mol % MgO; and from 0 mol % to about 5 mol % CaO; wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)−Al₂O₃≦2 mol %; 2 mol %≦Na₂O−Al₂O₃≦6 mol %; and 4 mol %≦(Na₂O+K₂O)−Al₂O₃≦10 mol %.

In another embodiment, the alkali aluminosilicate glass comprises: from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol % MgO+CaO≦10 mol %.

In another embodiment, the alkali aluminosilicate glass comprises SiO₂ and Na₂O, wherein the glass has a temperature T₃₅ₖₚ at which the glass has a viscosity of 35 kilo poise (kpoise), wherein the temperature T_{breakdown} at which zircon breaks down to form ZrO₂ and SiO₂ is greater than T₃₅ₖₚ. In some embodiments, the alkali aluminosilicate glass comprises: from about 61 mol % to about 75 mol % SiO₂; from about 7 mol % to about 15 mol % Al₂O₃; from 0 mol % to about 12 mol % B₂O₃; from about 9 mol % to about 21 mol % Na₂O; from 0 mol % to about 4 mol % K₂O; from 0 mol % to about 7 mol % MgO; and 0 mol % to about 3 mol % CaO.

In another embodiment, the alkali aluminosilicate glass comprises at least 50 mol % SiO₂ and at least one modifier selected from the group consisting of alkali metal oxides and alkaline earth metal oxides, wherein [(Al₂O₃ (mol %)+B₂O₃(mol %))/(Σ alkali metal modifiers (mol %))]>1. In some embodiments, the alkali aluminosilicate glass comprises: from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O.

In another embodiment, the alkali aluminosilicate glass comprises SiO₂, Al₂O₃, P₂O₅, and at least one alkali metal oxide (R₂O), wherein 0.75≦[(P₂O₅(mol %)+R₂O(mol %))/M₂O₃ (mol %)]≦1.2, where M₂O₃═Al₂O₃+B₂O₃. In some embodiments, the alkali aluminosilicate glass comprises: from about 40 mol % to about 70 mol % SiO₂; from 0 mol % to about 28 mol % B₂O₃; from 0 mol % to about 28 mol % Al₂O₃; from about 1 mol % to about 14 mol % P₂O₅; and from about 12 mol % to about 16 mol % R₂O; and, in certain embodiments, from about 40 to about 64 mol % SiO₂; from 0 mol % to about 8 mol % B₂O₃; from about 16 mol % to about 28 mol % Al₂O₃; from about 2 mol % to about 12% P₂O₅; and from about 12 mol % to about 16 mol % R₂O.

In still other embodiments, the alkali aluminosilicate glass comprises at least about 4 mol % P₂O₅, wherein (M₂O₃(mol %)/RₓO(mol %))<1, wherein M₂O₃═Al₂O₃+B₂O₃, and wherein RₓO is the sum of monovalent and divalent cation oxides present in the alkali aluminosilicate glass. In some embodiments, the monovalent and divalent cation oxides are selected from the group consisting of Li₂O, Na₂O, K₂O,Rb₂O, Cs₂O, MgO, CaO, SrO, BaO, and ZnO. In some embodiments, the glass comprises 0 mol % B₂O₃.

In still another embodiment, the alkali aluminosilicate glass comprises at least about 50 mol % SiO₂ and at least about 11 mol % Na₂O, and the compressive stress is at least about 900 MPa. In some embodiments, the glass further comprises Al₂O₃ and at least one of B₂O₃, K₂O, MgO and ZnO, wherein −340+27.1.Al₂O₃−28.7.B₂O₃+15.6.Na₂O−61.4.K₂O+8.1.(MgO+ZnO)≧0 mol %. In particular embodiments, the glass comprises: from about 7 mol % to about 26 mol % Al₂O₃; from 0 mol % to about 9 mol % B₂O₃; from about 11 mol % to about 25 mol % Na₂O; from 0 mol % to about 2.5 mol % K₂O; from 0 mol % to about 8.5 mol % MgO; and from 0 mol % to about 1.5 mol % CaO.

In some embodiments, the alkali aluminosilicate glasses described hereinabove are substantially free of (i.e., contain 0 mol % of) of at least one of lithium, boron, barium, strontium, bismuth, antimony, and arsenic.

In some embodiments, the alkali aluminosilicate glasses described hereinabove are down-drawable by processes known in the art, such as slot-drawing, fusion drawing, re-drawing, and the like, and has a liquidus viscosity of at least 130 kilopoise.

As previously described herein, glass article 100, in one embodiment, is chemically strengthened by an ion exchange process in which ions in the surface layer of the glass are replaced by larger ions having the same valence or oxidation state. In one particular embodiment, the ions in the surface layer and the larger ions are monovalent alkali metal cations, such as Li⁺ (when present in the glass), Na⁺, K⁺, Rb⁺, and Cs⁺. Alternatively, monovalent cations in the surface layer may be replaced with monovalent cations other than alkali metal cations, such as Ag⁺, Tl⁺, Cu⁺, or the like.

Ion exchange processes are typically carried out by immersing glass in a molten salt bath containing the larger ions. It will be appreciated by those skilled in the art that parameters for the ion exchange process, including, but not limited to, bath composition and temperature, immersion time, the number of immersions of the glass in a salt bath (or baths), use of multiple salt baths, and additional steps such as annealing, washing, and the like, are generally determined by the composition of the glass and the desired depth of layer and compressive stress of the strengthened glass that is to be achieved as a result of the strengthening operation. By way of example, ion exchange of alkali metal-containing glasses may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion items range from about 15 minutes up to about 16 hours.

In another embodiment, the strengthened glass article 100 may be strengthened by thermal tempering. In this technique, strengthened glass article 100 is heated up to a temperature that is greater than the strain point of the glass and rapidly cooled to a temperature below the strain point to create compressive surface layers 120, 122 in the glass.

In some embodiments, edges 140 and the at least one fracture line 150 are formed by laser separation of glass article 100 from a larger strengthened glass “mother” sheet using a method of controllably separating a strengthened glass sheet into multiple pieces or parts. The method of separation is described in U.S. patent application Ser. No. 12/388,837, filed Feb. 19, 2009, by Daniel Ralph Harvey et al. and entitled “Method of Separating Strengthened Glass;” and U.S. patent application Ser. No. 12/845,066, filed Jul. 28, 2010, by Matthew John Dejneka et al. and entitled “Method of Separating Strengthened Glass,” the contents of which are incorporated herein by reference in their entirety.

The laser separation method is controllable in the sense that the strengthened glass article 100 is separated from the strengthened glass mother sheet along a predetermined line or plane in a controlled or guided fashion. The method comprises forming at least one damage line in the central region and outside the strengthened surface layers of the strengthened glass mother sheet. A crack is then initiated and propagated along the at least one damage line to separate glass article 100 from the strengthened glass mother sheet.

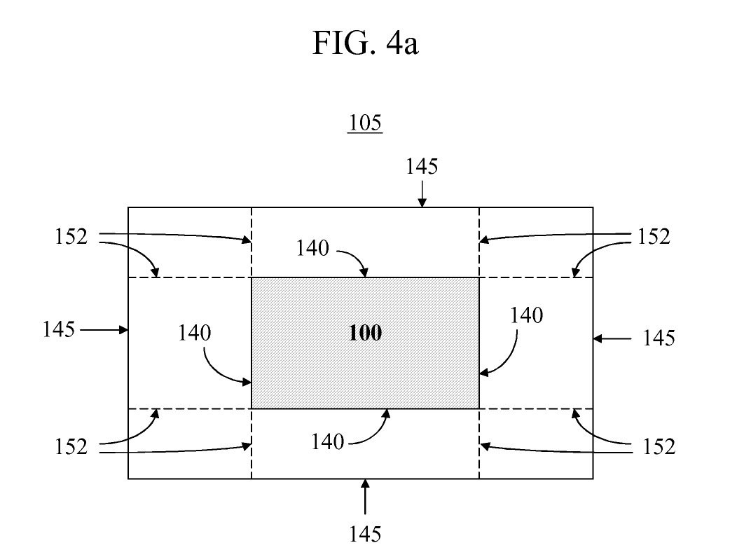

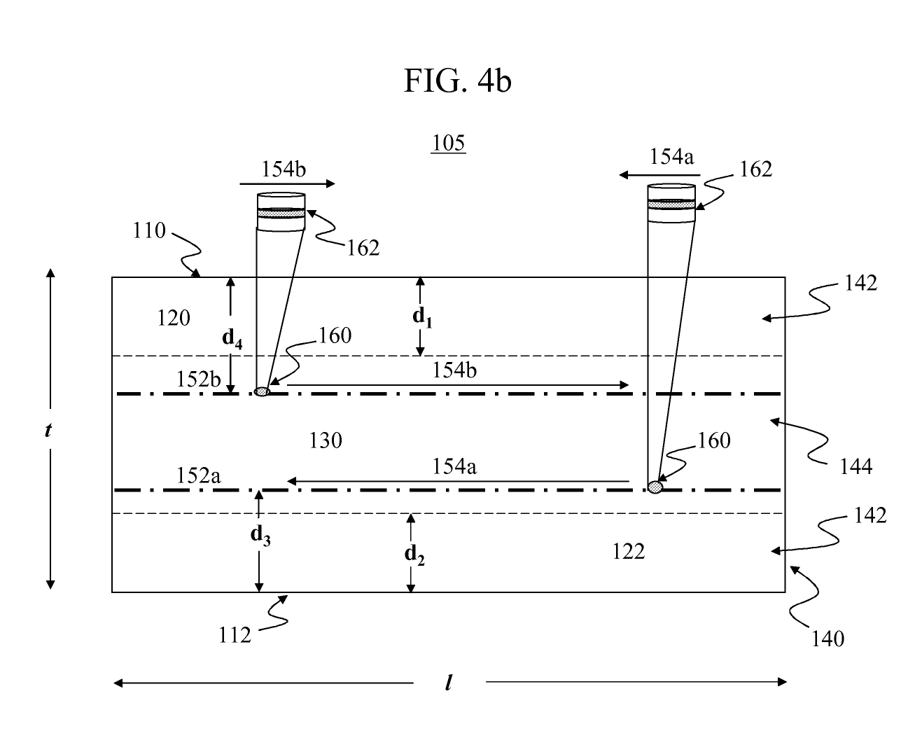

FIG. 4a is a schematic top view of a strengthened glass mother sheet 105 from which glass article 100 is separated by the laser separation method. Damage lines 152 are formed in the central region of strengthened glass mother sheet 105. At least one of damage lines 152 extends to and intersects an edge 145 of strengthened glass mother sheet 105. A crack is then initiated and propagated along at least one damage line 152 to separate strengthened glass article 100 with edges 140 from strengthened glass mother sheet 105. The crack may be initiated at the point where damage line 152 intersects edge 145 of strengthened glass mother sheet 105.

A cross-sectional view of one embodiment of the laser separation process is schematically shown in FIG. 4b. The at least one damage line 152a, 152b is formed within the central region 130 of the strengthened glass mother sheet 105 along a predetermined axis, line, or direction within strengthened glass mother sheet 105 and is located outside of strengthened surface layers 120, 122. The at least one damage line 152a, 152b is not formed within strengthened surface layers 120, 122, but in central region 130. The at least one damage line 152a, 152b is formed in a plane that forms an angle θ with first surface 110 or second surface 112 (FIG. 1a). In some embodiments, the plane is perpendicular to first surface 110 and second surface 112.

In one embodiment, the at least one damage line 152a, 152b is formed by irradiating the strengthened glass mother glass sheet 105, from which strengthened glass article 100 is separated, with a pulsed laser that operates in the transparency window of the glass transmission spectrum. The laser pulse is less than or equal to 500 ns and, in some embodiments, less than or equal to 300 ns and, in other embodiments, less than or equal to 150 ns. Damage within the bulk of the strengthened glass mother glass sheet and glass article 100 is generated by nonlinear absorption when the intensity or fluence of the laser beam exceeds a threshold value. Rather than creating damage lines by heating the glass, nonlinear absorption creates damage lines by breaking molecular bonds within the glass structure. The bulk of the strengthened mother glass sheet 105 and glass article 100 experiences no excessive heating when irradiated by the laser beam 160. Such lasers include those operating in the ultraviolet, visible, and infrared regions of the spectrum and having a pulse duration of less than or equal to 500 ns. In one embodiment, the laser 162 is a nanosecond pulsed Nd laser operating at the fundamental wavelength of 1064 nm, or harmonics thereof (e.g., 532 nm, 355 nm), with a repetition rate of up to 100-150 kHz. The power of the nanosecond-pulsed Nd laser is in a range from about 1 W up to about 3 W.

The formation of damage lines in the strengthened glass mother glass sheet by laser irradiation is schematically shown in FIG. 4b. A first laser-formed damage line 152a is formed by irradiating the strengthened glass mother glass sheet 105 with laser beam 160, which is generated by laser 162 and laser optics (not shown) that are needed to focus laser beam 160. Laser beam 160 is focused above second surface 112 and second strengthened surface layer 122 to form first damage line 150d. First damage line 152a is formed at a depth d₃ from second surface 112. Depth d₃ is greater than depth d₂ of second strengthened surface layer 122. Thus, first damage line 152a is located within central region 130, which is under tensile stress, and outside the surface region—i.e., second strengthened surface layer 122—that is under compressive stress. At least one of the strengthened glass mother glass sheet 105 and laser beam 160 is translated in direction 154a along line l of strengthened glass mother sheet 105 to form first damage line 152a. In one embodiment, the strengthened glass mother glass sheet 105 is translated with respect to laser beam 160. In another embodiment, laser beam 160 is translated with respect to the strengthened glass mother glass sheet 105. Such movement may be accomplished using translatable stages, tables, and the like that are known in the art. The damage lines extend to and intersect at least one edge of strengthened glass mother sheet 105.

After forming first damage line 152a, laser bean 160 is refocused below first surface 110 and first strengthened surface layer 120 to form second damage line 152b in central region 130. Second damage line 152b is formed at a depth d₄, which is greater than depth d₁ of first strengthened surface layer 120, and between first damage line 152a and first strengthened layer 120. Thus, second damage line 152b is located outside the surface region—i.e., first strengthened surface layer 120—that is under compressive stress.

In one embodiment, laser beam 160 is translated in direction 154b along line l of the strengthened glass mother glass sheet 105 to form second damage line 152b by moving at least one of the strengthened glass mother glass sheet 105 and laser beam 160. In one embodiment, direction 154b of translation of laser beam 160 or strengthened glass sheet 100 that is used to form second damage line 152b is opposite direction 154a of translation that is used to form first damage line 152a. In one embodiment, first damage line 152a, which is furthest from laser 162 and the associated laser optics, is formed first, followed by formation of second damage line 152b, which is closer to laser 162 and associated laser optics. In one embodiment, first and second damage lines 152a, 152b are formed by laser beam 160 at a rate ranging from about 30 cm/s up to about 50 cm/s. In another embodiment, first damage line 152a and second damage line 152b may be formed simultaneously by splitting laser beam 160.

In one embodiment, formation of first and second damage lines 152a, 152b includes overwriting, or making at least two passes, with laser beam 160 along each damage line; i.e., laser beam 160 is translated along each damage line at least two times, in some embodiments, sequentially or in succession of each other. This may be accomplished by splitting laser beam 160, providing multiple laser beams, or by other means known in the art, so as to make multiple passes simultaneously.

For the strengthened glass mother glass sheet 105 and strengthened glass article 100 each having a thickness t of about 1 mm, the depths d₃, d₄ of first and second damage lines 152a, 152b below first and second surfaces 110, 112, respectively, are in a range from about 50 μm up to about 350 μm. In one embodiment, depths d₃, d₄ are in a range from about 100 μm up to about 150 μm. In another embodiment, depths d₃, d₄ are in a range from about 100 μm up to about 150 μm. Damage lines are essentially parallel to and do not intersect surfaces 110, 112, and compressive layers 120, 122.

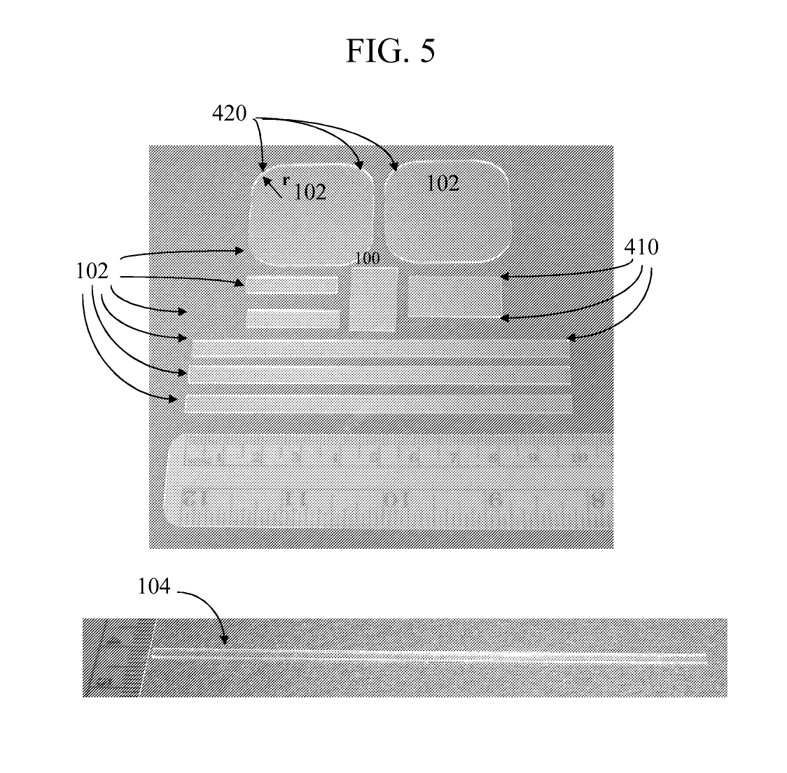

After forming the at least one damage line in the strengthened glass mother glass sheet 105, a crack is initiated and propagated to separate strengthened glass article 100 having the desired or predetermined dimensions and/or shape from the strengthened glass mother glass sheet 105. The crack may be introduced and/or propagate, in some embodiments, by bending or flexing the strengthened glass mother sheet 105. Strengthened glass article 100 is separated from strengthened glass mother glass sheet 105 along a plane defined by the damage lines (152a, 152b) formed within the strengthened glass mother glass sheet 105. Referring to FIG. 4b, strengthened glass sheet 100 is separated from strengthened glass mother glass sheet 105 along a predetermined line or path l defined by first damage line 152a and second damage line 152b to form edge 140 having at least one fracture line 150 (e.g., FIGS. 1a, 1b, and 2). In some embodiments, predetermined line or path l is a plane defined by first and second damage lines 152a, 152b. In those embodiments where the predetermined line or path is curved with radius r (e.g., forms a rounded or radiused corner (420 in FIG. 5), predetermined line or path l is plano-cylindrical.

Crack initiation, propagation, and separation may be accomplished by those means known in the art such, but not limited to, as manual or mechanical flexion of strengthened glass mother glass sheet 105 on opposite sides of the plane formed by the damage lines.

In another embodiment, crack initiation, propagation, and separation of strengthened glass sheet 100 from strengthened glass mother sheet 105 are achieved by immersing in a liquid such as water, after irradiating the strengthened glass mother sheet with a laser beam as described hereinabove. Immersing the laser-exposed strengthened glass mother sheet 105 in water results in breaking/separation along the damage lines 152a, 152b within about 5 to about 20 seconds with good consistency and visual quality. Four-point bending results show higher edge strength of samples separated by immersion compared to separation by manual flexion. Immersion of the laser-irradiated strengthened glass mother sheet 105 in a liquid such as water results in higher yields from the separation process separation and higher edge strengths of the resulting glass article. In addition, such immersion permits parts having higher aspect ratios to be obtained (104 in FIG. 5). Alternatively, crack initiation and propagation and separation may be achieved by wetting a damage line 152 at the point where it emerges from or intersects an edge of mother sheet 105 or glass article 100 (FIG. 4a).

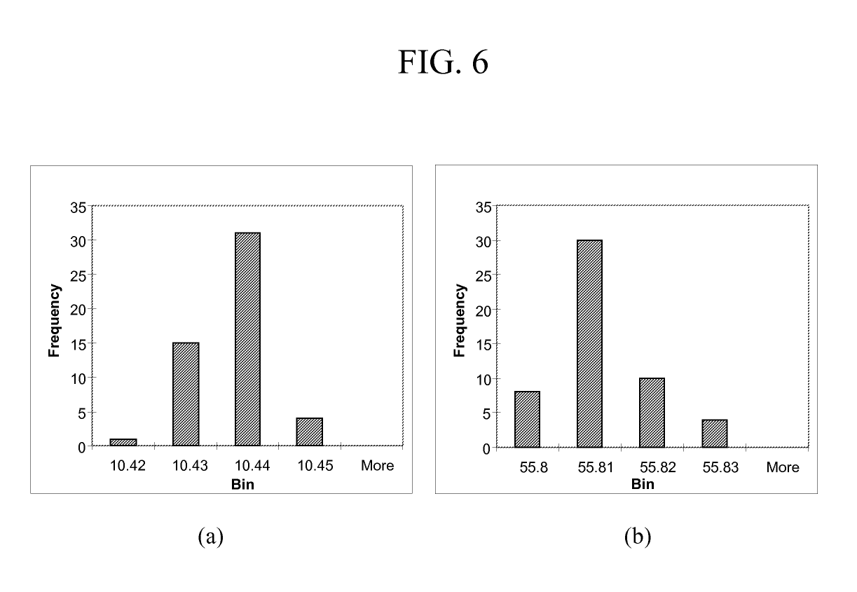

The dimensions of glass articles separated using the UV laser cutting method described hereinabove are highly consistent, with less that with than 10 μm variance from part to part. The dimensional consistency of parts formed using the laser separation methods described herein are shown in FIGS. 6a and 6b, which are histograms of width measurements for 10.4 mm×100 mm and 55.75 mm×100 mm laser separated glass articles, respectively.

In still another embodiment, full or complete separation (self-separation) of strengthened glass article 100 from strengthened glass mother sheet 105 by crack initiation, propagation, and separation may be achieved by repeated overwriting of first and second damage lines 152a, 152b with laser beam 160. For example, strengthened glass sheets of some alkali aluminosilicate glasses may be completely separated by overwriting first and second damage lines 152a, 152b at least twice with laser beam 160. Alternatively, the power of laser beam 160 may be increased to a level that is sufficient to achieve complete separation. Strengthened alkali aluminosilicate glass sheets may, for example, be completely separated by using a 355 nm nanosecond pulsed Nd laser having a power of at least 1 W.

Separation of strengthened glass article 100 from strengthened glass mother sheet 105 using the methods described herein results in reduced amounts of debris generated compared to those processes which require surface scribing and subsequent breaking of the strengthened glass mother sheet.

The ability of the UV laser separation process described herein to separate glasses of various compositions, thicknesses, and CT, CS, and DOL levels is summarized in Table 1. As seen in Table 1, separation by UV laser is not achieved for soda lime glass or in those instances where the central tension CT is less than about 21-22 MPa, whereas lower laser power is generally required to separate samples having higher central tension. In the one instance where the central tension exceeded the frangibility limit of the glass sample, the sample shattered upon contact with the laser beam.

TABLE 1
Summary of laser separation experiments.

| | | | CT, | | | | | |
|---|---|---|---|---|---|---|---|---|
| | DOL, | CS, | est. | Thickness, | Speed, | Laser | # of Lines × | |
| Glass | um | MPa | Mpa | mm | mm/s | Power, W | # of Passes | Comments |
| A | 0 | 0 | 0 | 0.95 | Unable to | Unable to | Unable to | Unable to |
| | | | | | separate | separate | separate | separate |
| Soda | 13 | 520 | 6 | 1.1 | 300 | 1.8-3 | 2 × 2 | Unable to |
| Lime | | | | | | | | separate |
| A | 15 | 822 | 13 | 0.95 | Unable to | Unable to | Unable to | Unable to |
| | | | | | separate | separate | separate | separate |
| B | 34 | 754 | 21 | 1.3 | 300 | 3.2 | 2 × 2 | Separated |
| B | 30 | 750 | 22 | 1.1 | 300 | 1.6-2 | 2 × 2 | Separated in |
| | | | | | | | | water |
| C | 38 | 758 | 24 | 1.3 | 300 | 3.2 | 2 × 2 | Separated |
| A | 34 | 111 | 28 | 0.95 | 300 | 2.6 | 2 × 2 | Separated |
| B | 39 | 731 | 28 | 1.1 | 300 | 1.5 | 2 × 2 | Separated |
| B | 39 | 739 | 28 | 1.1 | 300 | 1.5 | 2 × 2 | Separated |
| B | 43 | 689 | 29 | 1.1 | 300 | 1.5 | 2 × 2 | Separated |
| C | 35 | 871 | 33 | 1 | 300 | 3 | 2 × 2 | Separated |
| B | 54 | 725 | 33 | 1.3 | 300 | 1.8 | 2 × 2 | Separated |
| C | 59 | 615 | 37 | 1.1 | 300 | 3.0-3.5 | 2 × 2 | Separated |
| C | 61 | 724 | 37 | 1.3 | 300 | 1.8 | 2 × 2 | Separated |
| B | 59 | 663 | 40 | 1.1 | 300 | 1.3 | 2 × 2 | Separated |
| C | 50 | 843 | 42 | 1.1 | 300 | 3.2 | 2 × 2 | Separated |
| A | 52 | 735 | 45 | 0.95 | 300 | 1.6 | 2 × 2 | Separated |
| C | 65 | 685 | 46 | 1.1 | 300 | 3.2 | 2 × 2 | Separated |
| C | 57 | 831 | 53 | 1 | 300 | 2.5 | 2 × 2 | Separated |
| A | 34 | 698 | 55 | 0.5 | 300 | 1.6 | 2 × 2 | Separated |
| A | 70 | 658 | 57 | 0.95 | 300 | 1 | 2 × 2 | Separated |
| A | 51 | 692 | 59 | 0.7 | 300 | 1 | 2 × 2 | Separated |
| A | 50 | 641 | 71 | 0.55 | 300 | 1 | 2 × 1 | Separated |
| A | 82 | 740 | 77 | 0.95 | | 1 | | Shattered on |
| | | | | | | | | contact with |
| | | | | | | | | laser beam |
| C | 20 | 765 | 96 | 0.2 | 300 | 1.4 | 1 × 2 | Separated |

Glass A: Nominal composition: 66 mol % SiO₂; 10 mol % Al₂O₃; 0.6 mol % B₂O₃; 14 mol % Na₂O; 2 mol % K₂O; 6 mol % MgO; 0.6 mol % CaO; 0.01 mol % ZrO₂; 0.2 mol % SnO₂; 0.01 mol % Fe₂O₃.
Glass B: Nominal composition: 69 mol % SiO₂; 10 mol % Al₂O₃; 14 mol % Na₂O; 1 mol % K₂O; 6 mol % MgO; 0.5 mol % CaO; 0.01 mol % ZrO₂; 0.2 mol % SnO₂; 0.01 mol % Fe₂O₃.
Glass C: Nominal composition: 64 mol % SiO₂; 14 mol % Al₂O₃; 7 mol % B₂O₃; 14 mol % Na₂O; 0.5 mol % K₂O; 0.1 mol % MgO; 0.01 mol % ZrO₂; 0.1 mol % SnO₂; 0.03 mol % Fe₂O₃.

Using the methods described herein, strengthened glass article 100 may be separated or cut along a predetermined straight line (e.g., line l in FIG. 4b) from strengthened glass mother sheet 105 to form a plurality of smaller glass sheets with little or no chipping along the edge created by separation of strengthened glass sheet 100 from strengthened glass mother sheet 105. Since the strengthened glass article 100 is cut from a strengthened glass mother sheet 105, the edge 140 has regions 144 that are under a compressive stress and regions 142 that are not under a compressive stress.

Following separation from the mother sheet, edges 140 may be mechanically finished using those methods known in the art (e.g., grinding, polishing, and the like) to a desired shape such as, for example, a bullnose or chamfer with high yield (in some embodiments, about 90%). Such finishing decreases the edge strength due to the introduction of flaws. Edges 140 may be additionally etched after such finishing to increase their four point bend strength. In some embodiments, subsequent etching can raise the edge strength to at least 400 MPa and, in some embodiments, at least 600 MPa, as measured by four-point bend testing. One non-limiting example of such an edge strengthening process is described in U.S. patent application Ser. No. 12/862,096, filed Aug. 24, 2010, by John M. Matusick et al., and entitled “Method of Strengthening Edge of Glass Article,” the contents of which are incorporated herein by reference in their entirety.

The UV laser separation process described hereinabove may, in some embodiments, be used to separate strengthened glass sheets having a central tension of at least about 20 MPa.

FIG. 5 is a photograph showing a top view of strengthened glass articles produced by the laser separation method described hereinabove and having various shapes and aspect ratios. The samples shown in FIG. 5 have a thickness of 0.7 mm and a central tension (CT) of 41 MPa. Straight cuts may cross or intersect each other at right angles to yield cut glass sheets 102 having square corners 410. Alternatively, the methods described herein may be used to make radius cuts (i.e., a cut following an arc having radius r) in a strengthened glass mother sheet, thus providing cut glass articles 102 having rounded corners 420. Such radius cuts, in one embodiment, may have a radius r of greater than or equal to about 5 mm. Whereas cutting a strengthened glass sheet into narrow strips is problematic by means other than those described hereinabove, the methods described herein may be used to cut a strengthened glass sheet 104 into high aspect strips as narrow as 2 mm. Article 104 in FIG. 5 is a 0.7 mm thick glass strip having a width of 2 mm and a length of 100 mm. The methods described herein also allows strengthened glass sheets to be cut with zero-width kerf (i.e., substantially no loss of material at the point of separation) and with little or no generation of debris.

Accordingly, the strengthened glass article 100 described herein may, in some embodiments, have at least one rounded (radiused) corner with a corner radius of at least 5 mm. In other embodiments, glass article 100 may be a high aspect (length/width) article having an aspect ratio l/w of up to about 40.

Glass article 100, including edges 140, are under essentially zero thermal stress. The UV laser separation process described hereinabove is a “cold” separation process and does result in residual induced thermal stress. The laser induced damage in the central region, which is under tension, destroys the balance of forces in the strengthened glass. The damaged central region cannot prevent the surface compressive layers from expanding and, as a result, the glass separates along the damage lines. For example, when two damage lines are formed within the central tensile region of the mother glass using the UV laser separation process described herein with two overwrites at a scan speed of 300 mm/s and a laser power of 2 W, a 1 mm×1 mm cross-section of the glass will experience a 13.5 K temperature rise.

The glass article described herein may be used as a touch screen, a touch panel, a display panel, a window, a display screen, a cover plate, a casing, an enclosure, or the like for devices such as, but not limited to, electronic communication devices, electronic entertainment devices, and information terminal devices.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A glass article, the glass article having a thickness t, a length w, and a length l, the glass article comprising:
a. a first surface and a second surface parallel to the first surface, wherein each of the first surface and the second surface comprise a layer under a compressive stress CS;
b. a central region between the first surface and the second surface, wherein the central region is under a tensile stress CT;
c. an edge joining the first surface and the second surface, wherein a first portion of the edge is under compressive stress; and
d. a fracture line in a portion of the edge that is outside the first portion, wherein the fracture line is essentially parallel to the first surface and the second surface, and wherein the glass article is under zero thermal stress.

2. The glass article of claim 1, wherein the central tension is greater than 40 MPa.

3. The glass article of claim 2, wherein the central tension is less than −38.662 ln(t)(MPa)+48.214(MPa), where t is the thickness of the glass article, expressed in millimeters.

4. The glass article of claim 1, wherein the layer under compressive stress extends to a depth of at least 40 μm.

5. The glass article of claim 4, wherein the layer under compressive stress extends to a depth of at least 50 μm.

6. The glass article of claim 1, wherein the edge has a RMS roughness of at least about 0.5 μm.

7. The glass article of claim 1, wherein the glass article has a width w, a length l, and an aspect ratio l/w of up to about 40.

8. The glass article of claim 1, wherein the length and width meet at a rounded corner having a radius of at least about 5 mm.

9. The glass article of claim 1, wherein the glass article comprises an alkali aluminosilicate glass or an alkali aluminoborosilicate glass.

10. The glass article of claim 9, wherein the alkali aluminosilicate glass comprises: from about 64 mol % to about 68 mol % SiO₂; from about 12 mol % to about 16 mol % Na₂O; from about 8 mol % to about 12 mol % Al₂O₃; from 0 mol % to about 3 mol % B₂O₃; from about 2 mol % to about 5 mol % K₂O; from about 4 mol % to about 6 mol % MgO; and from 0 mol % to about 5 mol % CaO; wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)−Al₂O₃≧2 mol %; 2 mol %≦Na₂O−Al₂O₃≦6 mol %; and 4 mol %≦(Na₂O+K₂O)−Al₂O₃≦10 mol %.

11. The glass article of claim 9, wherein the alkali aluminosilicate glass comprises from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol %≦MgO+CaO≦10 mol %.

12. The glass article of claim 9, wherein the alkali aluminosilicate glass comprises SiO₂ and Na₂O, wherein the glass has a temperature T₃₅ₖₚ at which the glass has a viscosity of 35 kilo poise (kpoise), wherein the temperature T_{breakdown} at which zircon breaks down to form ZrO₂ and SiO₂ is greater than T₃₅ₖₚ.

13. The glass article of claim 12, wherein the alkali aluminosilicate glass comprises: from about 61 mol % to about 75 mol % SiO₂; from about 7 mol % to about 15 mol % Al₂O₃; from 0 mol % to about 12 mol % B₂O₃; from about 9 mol % to about 21 mol % Na₂O; from 0 mol % to about 4 mol % K₂O; from 0 mol % to about 7 mol % MgO; and 0 mol % to about 3 mol % CaO.

14. The glass article of claim 9, wherein the alkali aluminosilicate glass comprises least 50 mol % SiO₂ and at least one modifier selected from the group consisting of alkali metal oxides and alkaline earth metal oxides, wherein [(Al₂O₃ (mol %)+B₂O₃(mol %))/(Σ alkali metal modifiers (mol %))]>1.

15. The glass article of claim 14, wherein the alkali aluminosilicate glass comprises: from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O.

16. The glass article of claim 9, wherein the alkali aluminosilicate glass comprises at least about 50 mol % SiO₂ and at least about 11 mol % Na₂O, and the compressive stress is at least about 900 MPa.

17. The glass article of claim 15, wherein the alkali aluminosilicate the glass further comprises Al₂O₃ and at least one of B₂O₃, K₂O, MgO and ZnO, and wherein −340+27.1.Al₂O₃−28.7.B₂O₃+15.6.Na₂O−61.4.K₂O+8.1.(MgO+ZnO)≧0 mol %.

18. The glass article of claim 15, wherein the alkali aluminosilicate the glass comprises: from about 7 mol % to about 26 mol % Al₂O₃; from 0 mol % to about 9 mol % B₂O₃; from about 11 mol % to about 25 mol % Na₂O; from 0 mol % to about 2.5 mol % K₂O; from 0 mol % to about 8.5 mol % MgO; and from 0 mol % to about 1.5 mol % CaO.

19. The glass article of claim 1, wherein the edge is a laser formed edge.

20. The glass article of claim 1, wherein the glass article is cuttable by a laser having a pulse duration of less than or equal to 500 ns.

21. The glass article of claim 1, wherein the glass article is strengthened by ion exchange.

22. The glass article of claim 1, wherein the glass article is one of a touch screen, a touch panel, a display panel, a window, a display screen, a cover plate, a casing, and an enclosure for one of an electronic communication device, an electronic entertainment device, and an information terminal device.

23. A glass article, the glass article comprising:
a. a first surface and a second surface parallel to the first surface, wherein each of the first surface and the second surface comprise a layer under a compressive stress CS, the layer extending to a depth of layer of at least about 40 μm from each of the first surface and the second surface into the glass article;
b. a central region between the first surface and the second surface, wherein the central region is under a tensile stress CT of greater than 40 MPa; and
c. an edge joining the first surface and the second surface, wherein a first portion of the edge is under a compressive stress.

24. The glass article of claim 23, wherein the edge comprises a fracture line outside the first portion of the edge, and wherein the fracture line is essentially parallel to the first surface and the second surface.

25. The glass article of claim 23, wherein the glass article is under zero thermal stress.

26. The glass article of claim 23, wherein the central tension is less than −38.662 ln(t)(MPa)+48.214 (MPa).

27. The glass article of claim 23, wherein the glass article comprises an alkali aluminosilicate glass or an alkali aluminoborosilicate glass.

28. The glass article of claim 27, wherein the alkali aluminosilicate glass comprises: from about 64 mol % to about 68 mol % SiO₂; from about 12 mol % to about 16 mol % Na₂O; from about 8 mol % to about 12 mol % Al₂O₃; from 0 mol % to about 3 mol % B₂O₃; from about 2 mol % to about 5 mol % K₂O; from about 4 mol % to about 6 mol % MgO; and from 0 mol % to about 5 mol % CaO; wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)−Al₂O₃≧2 mol %; 2 mol %≦Na₂O−Al₂O₃≦6 mol %; and 4 mol % (Na₂O+K₂O)−Al₂O₃≦10 mol %.

29. The glass article of claim 27, wherein the alkali aluminosilicate glass comprises from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol %≦MgO+CaO≦10 mol %.

30. The glass article of claim 27, wherein the alkali aluminosilicate glass comprises SiO₂ and Na₂O, wherein the glass has a temperature T₃₅ₖₚ at which the glass has a viscosity of 35 kilo poise (kpoise), wherein the temperature T_{breakdown} at which zircon breaks down to form ZrO₂ and SiO₂ is greater than T₃₅ₖₚ.

31. The glass article of claim 30, wherein the alkali aluminosilicate glass comprises: from about 61 mol % to about 75 mol % SiO₂; from about 7 mol % to about 15 mol % Al₂O₃; from 0 mol % to about 12 mol % B₂O₃; from about 9 mol % to about 21 mol % Na₂O; from 0 mol % to about 4 mol % K₂O; from 0 mol % to about 7 mol % MgO; and 0 mol % to about 3 mol % CaO.

32. The glass article of claim 27, wherein the alkali aluminosilicate glass comprises least 50 mol % SiO₂ and at least one modifier selected from the group consisting of alkali metal oxides and alkaline earth metal oxides, wherein [(Al₂O₃ (mol %)+B₂O₃(mol %))/(Σ alkali metal modifiers (mol %))]>1.

33. The glass article of claim 32, wherein the alkali aluminosilicate glass comprises: from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O.

34. The glass article of claim 27, wherein the alkali aluminosilicate glass comprises at least about 50 mol % SiO₂ and at least about 11 mol % Na₂O, and the compressive stress is at least about 900 MPa.

35. The glass article of claim 34, wherein the alkali aluminosilicate the glass further comprises Al₂O₃ and at least one of B₂O₃, K₂O, MgO and ZnO, and wherein −340+27.1.Al₂O₃−28.7.B₂O₃+15.6.Na₂O−61.4.K₂O+8.1.(MgO+ZnO)≧0 mol %.

36. The glass article of claim 34, wherein the alkali aluminosilicate the glass comprises: from about 7 mol % to about 26 mol % Al₂O₃; from 0 mol % to about 9 mol % B₂O₃; from about 11 mol % to about 25 mol % Na₂O; from 0 mol % to about 2.5 mol % K₂O; from 0 mol % to about 8.5 mol % MgO; and from 0 mol % to about 1.5 mol % CaO.

37. The glass article of claim 23, wherein the edge is a laser formed edge.

38. The glass article of claim 23, wherein the glass article is cuttable by a laser having a pulse duration of less than or equal to 500 ns.

39. The glass article of claim 23, wherein the glass article is strengthened by ion exchange.

40. The glass article of claim 23, wherein the glass article is one of a touch screen, a touch panel, a display panel, a window, a display screen, a cover plate, a casing, and an enclosure for one of an electronic communication device, an electronic entertainment device, and an information terminal device.

41. The glass article of claim 23, wherein the glass article is formed by:
a. providing a strengthened glass sheet, the strengthened glass sheet having a central region disposed between the first surface and the second surface, wherein the central region is under a tensile stress CT of at least about 40 MPa;
b. forming at least one damage line in the central region; and
c. initiating and propagating a crack to separate the glass sheet along the at least one damage line to form the glass article.

42. The glass article of claim 41, wherein the glass sheet self separates.

43. The glass article of claim 42, wherein the strengthened glass sheet is separated by manual or mechanical flexion of the strengthened glass sheet.
